(19) United States
(12) Patent Application Publication
(10) Pub. No.: US 2021/0315155 A1
(43) Pub. Date: Oct. 14, 2021

(54) A DOCKING STATION FOR USE WITH AN AUTONOMOUS TOOL, AN AUTONOMOUS LAWN MOWER AND A METHOD OF GUIDING AN AUTONOMOUS TOOL TOWARDS A DOCKING STATION

(71) Applicant: TECHTRONIC CORDLESS GP, Anderson, SC (US)

(72) Inventors: Hei Man Raymond Lee, Kwai Chung (CN); Ngai Cheung, Kwai Chung (CN); Dohoon Kim, Kwai Chung (CN); Denis Gaston Fauteux, Kwai Chung (CN); Hal Llan, Guangdong (CN)

(21) Appl. No.: 17/273,629

(22) PCT Filed: Sep. 28, 2018
(86) PCT No.: PCT/CN2018/108370

§ 371 Date: Mar. 4, 2021

(51) Int. Cl. A01D 34/00; G05D 1/02

(52) U.S. Cl. CPC A01D 34/008; G05D 1/0225; G05D 2201/0208; G05D 1/0259; G05D 1/0234

(57) ABSTRACT

A docking station for use with an autonomous tool comprising a docking module for detachably receiving the autonomous tool and a guiding module arranged to guide the movement of the autonomous tool towards the docking module, wherein the autonomous tool, upon termination of the movement, is received by the docking module at a predetermined position and orientation. The present invention also discloses an autonomous lawn mower having a docking module and a guiding module and a method of guiding an autonomous tool towards a docking station.

A docking station for use with an autonomous tool (100) comprises a docking module (200) for detachably receiving the autonomous tool (100) and a guiding module (210) arranged to guide the movement of the autonomous tool (100) towards the docking module (200), wherein the autonomous tool (100), upon termination of the movement, is received by the docking module (200) at a predetermined position and orientation (400). An autonomous lawn mower has a docking module (200) and a guiding module (210). A method is applied to guide an autonomous tool (100) towards a docking station.

### TECHNICAL FIELD

The present invention relates to a docking station for use with an autonomous tool and a method of guiding an autonomous tool towards a docking station, wherein the autonomous tool is particularly, although not exclusively, an autonomous lawn mower.

### BACKGROUND

Increasingly hectic lifestyles combined with a shortage of labour are some of the primary contributors to the growing popularity of, and increasing reliance on, autonomous tools worldwide. Autonomous tools have both commercial and personal applications, minimising the need for user intervention while operating effectively and efficiently.

Autonomous tools are battery powered and need to be recharged on a regular basis. Docking stations act as a convenient point for the autonomous tool to return to after completion of its tasks whilst also doubling as a recharging point if and when necessary. Improved docking stations for use with autonomous tools are desired.

### SUMMARY OF THE INVENTION

In the light of the foregoing background, it is an object of the present invention to provide a docking station for use with an autonomous tool which eliminates or at least alleviates at least one of the above technical problems.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

In accordance with a first aspect of the present invention, there is provided a docking station for use with an autonomous tool comprising:
a docking module for detachably receiving the autonomous tool;
a guiding module arranged to guide the movement of the autonomous tool towards the docking module;
wherein the autonomous tool, upon the termination of the movement, is received by the docking module at a predetermined position and orientation.

In an embodiment of the first aspect, the guiding module is extended from the docking module and comprises at least one guiding member.

In an embodiment of the first aspect, the guiding module comprises a pair of guiding members with a first end adjacent to the docking module and a second end opposed.

In an embodiment of the first aspect, the at least one guiding member or the pair of guiding members is arranged to guide the movement of the autonomous tool towards the docking module such that the autonomous tool is received by the docking module.

In an embodiment of the first aspect, the pair of guiding members are extended from the docking module in a parallel manner.

In an embodiment of the first aspect, the pair of guiding members are extended from the docking module in a non-parallel manner.

In an embodiment of the first aspect, the pair of guiding members converge as they approach the docking module such that the second ends of the pair of guiding members are spaced further apart than the first ends of the pair of guiding members.

In an embodiment of the first aspect, the at least one guiding member is a guide rail.

In an embodiment of the first aspect, the first end of the guiding members are connected to form a substantially U-shaped guiding member.

In an embodiment of the first aspect, the first end of the guiding members are connected to form a substantially V-shaped guiding member.

In an embodiment of the first aspect, the docking module further comprises a signal generating module the signal emitted by which is received by a signal detecting module of the autonomous tool.

In accordance with a second aspect of the present invention, there is provided an autonomous lawn mower comprising:
a mower body having at least one motor arranged to drive a cutting blade and to propel the mower body on an operating surface via a wheel arrangement, wherein the mower body includes a navigation system arranged to assist a controller to control the operation of the mower body within a predefined operating area, and
a docking module for detachably receiving the mower body;
a guiding module arranged to guide the movement of the autonomous lawn mower towards the docking module;
wherein the autonomous lawn mower, upon the termination of the movement, is received by the docking module at a predetermined position and orientation.

In an embodiment of the second aspect, the guiding module is extended from the docking module and comprises one or more guiding members.

In an embodiment of the second aspect, the one or more guiding members is arranged to guide the movement of the autonomous lawn mower towards the docking module such that the autonomous lawn mower is received by the docking module.

In an embodiment of the second aspect, the guiding module comprises a pair of guiding members with a first end adjacent to the docking module and a second end opposed.

In an embodiment of the second aspect, the pair of guiding members are extended from the docking module in a parallel manner.

In an embodiment of the second aspect, the pair of guiding members are extended from the docking module in a non-parallel manner.

In an embodiment of the second aspect, the pair of guiding members converge as they approach the docking module.

In an embodiment of the second aspect, the first end of the guiding members are connected to form a substantially U-shaped guiding member.

In an embodiment of the second aspect, the first end of the guiding members are connected to form a substantially V-shaped guiding member.

In an embodiment of the second aspect, the docking module further includes a signal generating module the signal emitted by which is received by a signal detecting module of the autonomous lawn mower.

In accordance with a third aspect of the present invention, there is provided a method of guiding an autonomous tool towards a docking station, the docking station including: a docking module for detachably receiving the autonomous tool, and a guiding module for guiding the movement of the autonomous tool towards the docking module, wherein the autonomous tool, upon the termination of the movement, is received by the docking module at a predetermined position and orientation, the method comprising the steps of:
(a) guiding, by the guiding module, the movement of the autonomous tool towards the docking module;
(b) receiving, by the docking module, upon termination of the movement, the autonomous tool at the predetermined position and orientation.

In an embodiment of the third aspect, the method further includes step (a1), before step (a), of retrieving the position of the docking module relative to the autonomous tool.

In an embodiment of the third aspect, the method further includes step (a2), following step (a1), of deriving a path for the movement of the autonomous tool towards the docking module.

In an embodiment of the third aspect, the guiding module is extended from the docking module and comprises at least one guiding member.

In an embodiment of the third aspect, the guiding module comprises a pair of guiding members with a first end adjacent to the docking module and a second end opposed.

In an embodiment of the third aspect, the pair of guiding members are extended from the docking module in a parallel manner.

In an embodiment of the third aspect, the pair of guiding members are extended from the docking module in a non-parallel manner.

In an embodiment of the third aspect, the pair of guiding members converge as they approach the detachable docking module such that the second ends of the pair of guiding members are spaced further apart than the first ends of the pair of guiding members.

In an embodiment of the third aspect, the first end of the guiding members are connected to form a substantially U-shaped guiding member.

In an embodiment of the third aspect, the first end of the guiding members are connected to form a substantially V-shaped guiding member.

In an embodiment of the third aspect, the docking module comprises a signal generating module the signal emitted by which is received by a signal detecting module of the autonomous tool.

### BRIEF DESCRIPTION OF THE DRAWINGS

Embodiments of the present invention will now be described, by way of example, with reference to the accompanying drawings in which:

FIG. 1 is an illustration of an autonomous lawn mower in accordance with one embodiment of the present invention;

FIG. 2 a diagram showing an example implementation of a docking station for use with an autonomous tool;

FIG. 3 is a diagram showing another example implementation of a docking station for use with an autonomous tool;

FIG. 4 is a diagram showing an example implementation of a docking station with a boundary wire loop; and

FIG. 5 is a flow diagram of a method of guiding an autonomous tool towards a docking station in accordance with one embodiment of the present invention.

### DETAILED DESCRIPTION OF THE PREFERRED EMBODIMENT

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Terms such as “horizontal”, “vertical”, “upwards”, “downwards”, “above”, “below” and similar terms as used herein are for the purpose of describing the invention in its normal in-use orientation and are not intended to limit the invention to any particular orientation.

Without wishing to be bound by theories, the inventors, through their own trials and experiments, devised that proper alignment and correct positioning or orientation of an autonomous tool with respect to a receiving docking station is of essence importance. Any misalignment or incorrect positioning or orientation may result in a bad electrical contact therebetween and in turn cause recharging issues. Inevitably, user manual handling may be the only available remedy action. As such, user experience is below satisfactory.

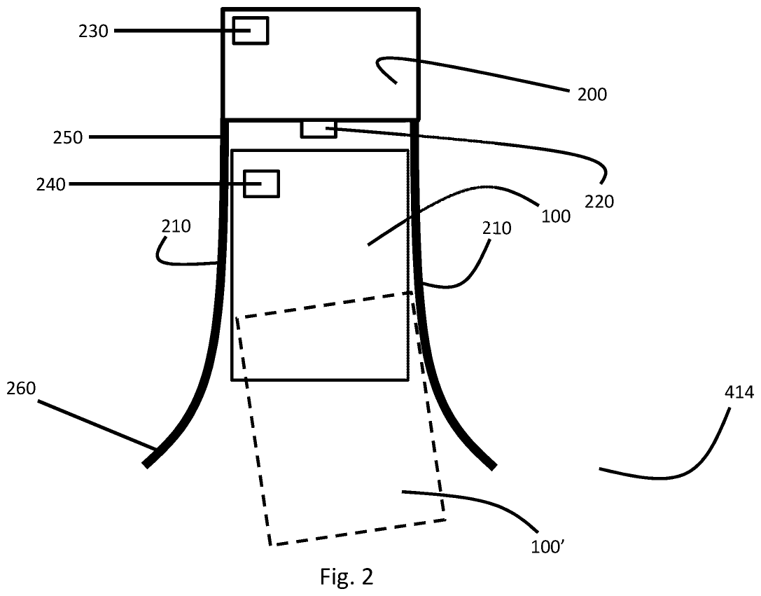

With reference to FIGS. 2-4, there is provided a docking station 200 for use with an autonomous tool 100, comprising: a docking module 200 for detachably receiving the autonomous tool 100 and a guiding module 210 arranged to guide the movement of the autonomous tool 100. Upon termination of the movement of the autonomous tool 100, the autonomous tool 100 is received by the docking module 200 at a predetermined position and orientation 400.

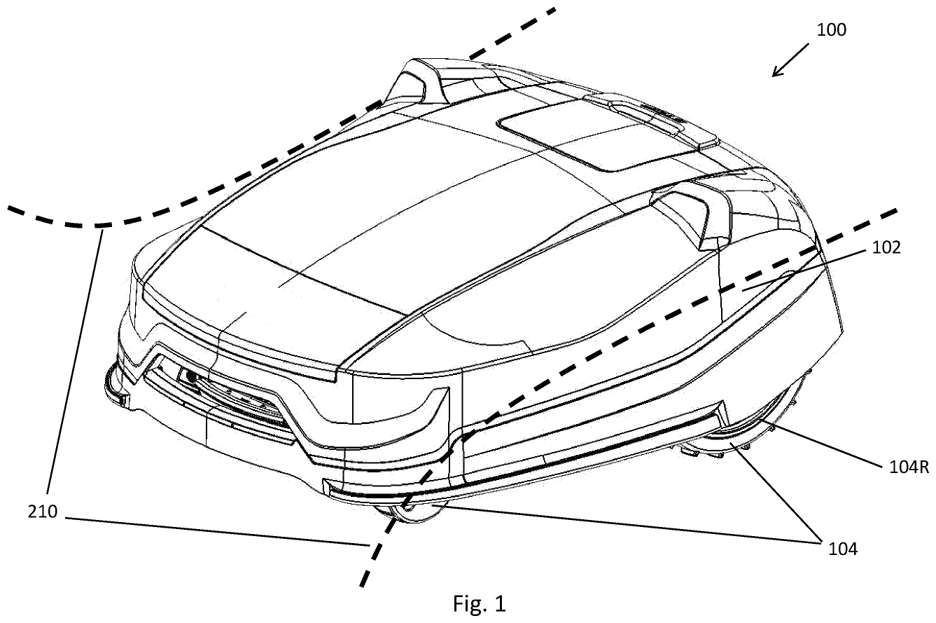

The autonomous tool 100 may be any outdoor or indoor tool used for personal or commercial purposes which can operate autonomously or with minimal user intervention. Examples of autonomous tools 100 include, but are not limited to, any type of grass cutting device or lawn mower capable of autonomous operation. With reference to FIG. 1, an autonomous tool has been incorporated as an autonomous lawn mower 100 in a preferred example embodiment.

In this example, the autonomous lawn mower 100 is arranged to operate on a lawn or grass grown surface so as to cut the grass. This action is commonly known as “mowing the lawn” and is often undertaken by gardeners and landscape workers to maintain a lawn surface. The term autonomous lawn mower 100 may also include any type of grass cutting device or lawn mower which can operate autonomously, that is, with minimum user intervention. It is expected that user intervention at some point is required to set up or initialize the mower 100 or to calibrate the mower 100 with specific commands, but once these procedures have been undertaken, the mower 100 is largely adapted to operate on its own until further commands are required or if servicing, calibration or error correction is required. Accordingly, autonomous lawn mowers 100 may also be known as automatic lawn mowers, self-driven lawn mowers, robotic lawn mowers or the like.

In this embodiment as shown in FIG. 1, the autonomous lawn mower 100, or referred to as the lawn mower or mower, includes a frame or housing 102 which supports the operating components of the mower 100. These operating components may include, without limitation, at least one motor, such as an electric motor, which is arranged to drive the blades of the mower 100 so as to cut the grass of a lawn to which the mower 100 is mowing. The at least one motor may also be used to drive the mower 100 itself via the means of transmission systems, such as gearing mechanisms or gearboxes which transmit a driving force to its wheel arrangements 104, although preferably, as is the case of this embodiment, separate motors are used to drive the mower 100 along its operating surface with each rear wheel 104R having its own individual motor and gearbox. This is advantageous in that manoeuvring the mower 100 may be implemented by simple control of each of these motors. It is important to note that the term wheel arrangements may also include driving arrangements that are formed from various different types and combination of wheels, including tracks (such as in tank tracks), chains, belts (such as in snow belts) or other forms of driving arrangements.

Preferably, as shown in the embodiment of FIG. 1, the mower 100 includes a navigation system which operates to locate and navigate the mower 100 around a working area 414 so that the mower 100 can cut the grass of a working area 414. The navigation system is arranged to assist a controller which processes the navigation information and generates commands which are used to control the movement and operation of the mower 100 within a work or operation area.

The autonomous tool as described previously has been incorporated as an autonomous lawn mower in an example embodiment. With reference to FIG. 1, there is provided an autonomous lawn mower 100 comprising: mower body 102 having at least one motor arranged to drive a cutting blade and to propel the mower body 102 on an operating surface via a wheel arrangement 104, wherein the mower body 102 includes a navigation system arranged to assist a controller to control the operation of the mower body 102 within a predefined operating area 414, a docking module 200 for detachably receiving the mower body 102 and a guiding module 210 arranged to guide the movement of the autonomous lawn mower 100 towards the docking module 200, wherein the autonomous lawn mower 100, upon termination of the movement, is received by the docking module 200 at a predetermined position and orientation 400.

In this example, the autonomous tool 100 is dockable with a docking station 200. The docking station 200 includes a docking module 200 that detachably receives the autonomous tool 100 at a predetermined position and orientation 400. The docking station 200 can act as a parking bay for an autonomous tool 100 when it is, for example, not in use or when it has completed its operations. Docking with a docking station 200 also allows the autonomous tool 100 to recharge its battery if determined to be low, i.e. below a predetermined threshold. Therefore, in practice, the autonomous tool 100 may navigate around an operating area 414 completing its tasks, i.e. mowing a lawn, whereby it returns to the docking station 200 at an appropriate time, for example when the charge level of the battery is low or the tool 100 has completed its required tasks or is on standby mode until the next command is generated.

Preferably, the autonomous tool 100 is received by the docking module 200 at a predetermined position and orientation 400. In one example embodiment, the autonomous tool 100 may include a navigation system, for instance, using sensors 222FL, 222FR, 222R, for implementing suitable localization and mapping functionality to enable the autonomous tool 100 to navigate around a defined operating area 414 and return to its original position, in this case the location of the docking station 200, by following a boundary 410. The two front sensors 222FL, 222FR may be placed on either side of the boundary 410 ensure maximal adherence to the boundary and accurate navigation. The navigation system may in practice simply place the autonomous tool 100 in front of or near the docking station and not in the predetermined position and orientation 400 as needed for receipt by the docking module 200.

Advantageously, the guiding module 210 guides the autonomous tool 100 to the predetermined position and orientation 400 where it is received by the docking module 200. The guide module 210 therefore provides a tolerance or deviation that accounts for any inaccuracies or limitations of the resolutions of the sensors 222FL, 222FR, 222R in the navigation system and adjusts or alters the movement of the autonomous tool 100 to ensure that the autonomous tool 100 is positioned at the correct position, i.e. the predetermined position and orientation 400, for docking. Positional or orientation adjustment of the autonomous tool 100 may be needed, for example, for successful or accurate coupling of the tool 100 with a contact means 220 on the docking module 200 for recharging of the tool battery.

The guiding member(s) 210 guide the movement of the autonomous tool 100 towards the docking module 200 such that the tool 100 is received by the docking module 200. The guiding members 210 advantageously minimise docking or recharging issues resulting from misalignment or incorrect positioning or orientation of the autonomous tool 100 with the docking module 200, thus increasing the efficiency of the tool and reducing the need for user intervention by minimising technical problems associated with docking issues.

In an example embodiment, the guiding module 210 is extended from the docking module 200 and includes at least one guiding member 210. The guiding module 210 may be permanently or detachably affixed to the docking module 200. Alternatively, the guiding module 210 may be positioned adjacent, but separately and not extending from, the docking module 200 and may be anchored to a surface such as the ground for support.

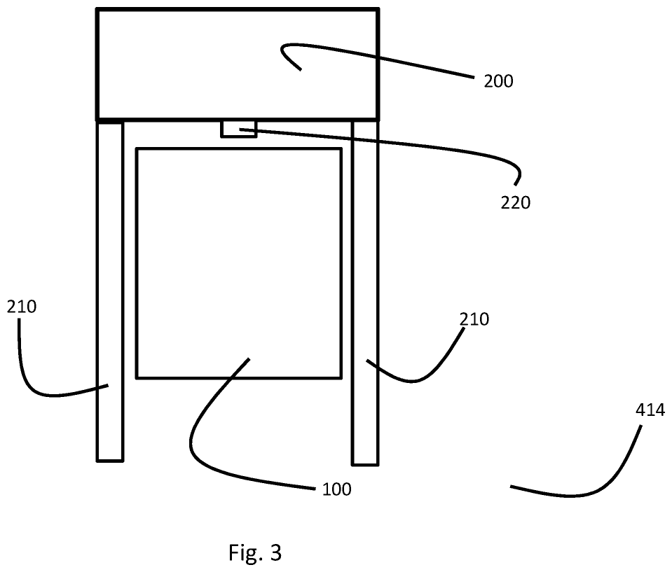

In a preferred embodiment the guiding module 210 includes a pair of guiding members 210 as illustrated in FIGS. 2 and 3. The pair of guiding members 210 have a first end 250 adjacent to the docking module 200 and a second end 260 opposed.

In an alternative embodiment, the pair of guiding members 210 may be detachably integrated into one guiding member 210.

The pair of guiding members 210 provide a channel for guided movement of the autonomous tool 100 towards the docking module 200. With reference to FIG. 2, in an example embodiment the pair of guided members 210 extend from the docking module in a non-parallel manner.

Preferably, the pair of guided members 210 converges as they approach the docking module 200 such that the second ends 260 of the pair of guiding members 210 are spaced further apart than the first ends 250 of the pair of guiding members 210. For example, the pair of guiding members 210 may be spaced furthest apart at the second ends 260 gradually reducing the spacing between them, i.e.

becoming less spaced apart, as they move towards the docking module 200 such that they are spaced closest together at the first end 250.

In one example embodiment, the first end 250 of the guiding members 210 are connected to form a substantially U-shaped guiding member 210 as shown in FIG. 2. The guiding members 210 may each have a slight curve towards the second ends 260 which straighten to form straight lines in a parallel manner as they approach the first ends 250.

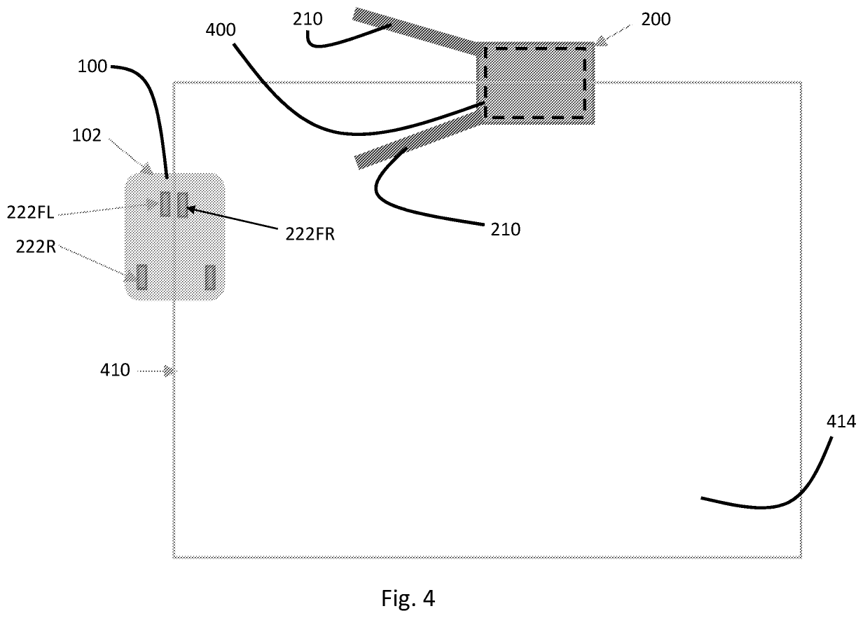

In a further example embodiment, the first ends 250 of the guiding members 210 are connected to form a substantially V-shaped guiding member 210 as illustrated in FIG. 4. The guiding members 210 may widen in a linear manner as they extend from the first end 250 to the second end 260.

Alternatively, the pair of guided members 210 may extend from the docking module 200 in a parallel manner as shown in FIG. 3. In an example embodiment, the guiding member 210 may be a guide rail with tracks that guide wheeling of the autonomous tool 100.

In another example embodiment, the guided members 210 may be in the form of fencing that provides a guiding tunnel or channel for the autonomous tool 100 to move towards the docking module 200.

The guiding members 210 may, in an example embodiment, communicate with the autonomous tool 100 by generating a signal if the tool 100 comes into contact or hits the guiding member 210. The signal by the guiding member 210 would then be received by the autonomous tool 100 sensors 222FL, 222FR, 222R and processed by the controller such that appropriate navigational changes would be made to ensure correct alignment of the autonomous tool 100 with the docking module 200.

In one example embodiment, the docking module 200 includes a signal generating module 230 the signal emitted by which is received by a signal detecting module 240 of the autonomous tool 100. The signal may provide navigational markers as to the positioning of the autonomous tool 100 relative to the docking module 200 and aid in the alignment of the tool 100 with the docking module 200.

In an example embodiment, the autonomous lawn mower may include a signal detecting module 222 arranged to detect a signal representation of a navigational marker.

The navigation modules may include an odometry module to aid in ensuring the mower body 102 is received in the docking module 200.

Other additional navigation modules may also be implemented to communicate with the guiding module 210 and docking module 200 to adjust and align the mower body 102 with the docking module 200.

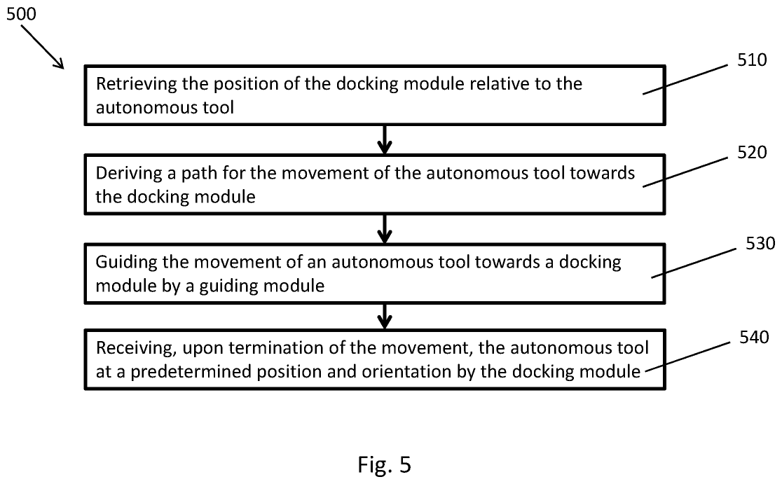

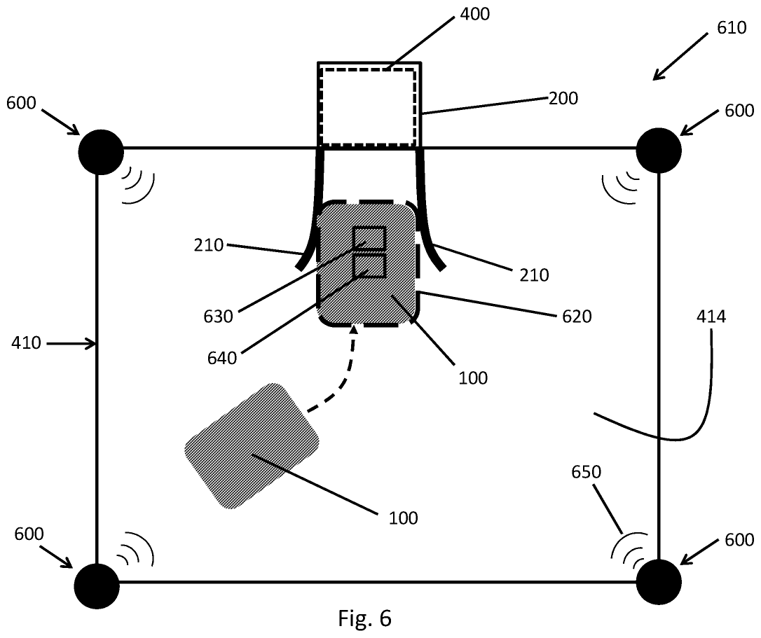

With reference to FIG. 5, the flow diagram 500 provides an example embodiment of a method of guiding the autonomous tool 100 towards a docking station 200, as described above.

Initially, the position of the docking module 200 relative to the autonomous tool 100 is retrieved at step 510 and a path for the movement of the autonomous tool 100 towards the docking module 200 is derived based on the relative position of the autonomous tool 100 or the docking module 200 at step 520. However, the derived path may be slightly misaligned with the docking module 200.

During the docking process, the movement of the autonomous tool towards the docking module 200 is guided by a guiding module 210 at step 530, and finally, upon the termination of the movement, the autonomous tool 100 would be located at a predetermined position and orientation 400 and received by the docking module 200 at step 540.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

Any reference to prior art contained herein is not to be taken as an admission that the information is common general knowledge, unless otherwise indicated.

1. A docking station for use with an autonomous tool, comprising:
a docking module for detachably receiving the autonomous tool;
a guiding module arranged to guide the movement of the autonomous tool towards the docking module;
wherein the autonomous tool, upon the termination of the movement, is received by the docking module at a predetermined position and orientation.

2. A docking station in accordance with claim 1, wherein the guiding module is extended from the docking module and comprises at least one guiding member.

3. A docking station in accordance with claim 1, wherein the guiding module comprises a pair of guiding members with a first end adjacent to the docking module and a second end opposed.

4. A docking station in accordance with claim 2, wherein the at least one guiding member or the pair of guiding members is arranged to guide the movement of the autonomous tool towards the docking module such that the autonomous tool is received by the docking module.

5. A docking station in accordance with claim 3, wherein the pair of guiding members are extended from the docking module in a parallel manner.

6. A docking station in accordance with claim 3, wherein the pair of guiding members are extended from the docking module in a non-parallel manner.

7. A docking station in accordance with claim 6, wherein the pair of guiding members converge as they approach the docking module such that the second ends of the pair of guiding members are spaced further apart than the first ends of the pair of guiding members.

8. A docking station in accordance with claim 2, wherein the at least one guiding member is a guide rail.

9. A docking station in accordance with claim 3, wherein the first end of the guiding members are connected to form a substantially U-shaped guiding member.

10. A docking station in accordance with claim 3, wherein the first end of the guiding members are connected to form a substantially V-shaped guiding member.

11. A docking station in accordance with claim 1, wherein the docking module further comprises a signal generating module the signal emitted by which is received by a signal detecting module of the autonomous tool.

12. An autonomous lawn mower comprising:
a mower body having at least one motor arranged to drive a cutting blade and to propel the mower body on an operating surface via a wheel arrangement, wherein the mower body includes a navigation system arranged to assist a controller to control the operation of the mower body within a predefined operating area, and
a docking module for detachably receiving the mower body;
a guiding module arranged to guide the movement of the autonomous lawn mower towards the docking module;
wherein the autonomous lawn mower, upon the termination of the movement, is received by the docking module at a predetermined position and orientation.

13. An autonomous lawn mower in accordance with claim 12, wherein the guiding module is extended from the docking module and comprises one or more guiding members.

14. An autonomous lawn mower in accordance with claim 13, wherein the one or more guiding members is arranged to guide the movement of the autonomous lawn mower towards the docking module such that the autonomous lawn mower is received by the docking module.

15. An autonomous lawn mower in accordance with claim 13, wherein the guiding module comprises a pair of guiding members with a first end adjacent to the docking module and a second end opposed.

16. An autonomous lawn mower in accordance with claim 15, wherein the pair of guiding members are extended from the docking module in a parallel manner.

17. An autonomous lawn mower in accordance with claim 15, wherein the pair of guiding members are extended from the docking module in a non-parallel manner.

18. An autonomous lawn mower in accordance with claim 15, wherein the pair of guiding members converge as they approach the docking module.

19. An autonomous lawn mower in accordance with claim 15, wherein the first end of the guiding members are connected to form a substantially U-shaped guiding member.

20. An autonomous lawn mower in accordance with claim 15, wherein the first end of the guiding members are connected to form a substantially V-shaped guiding member.

21. An autonomous lawn mower in accordance with claim 12, wherein the docking module further includes a signal generating module the signal emitted by which is received by a signal detecting module of the autonomous lawn mower.

22. A method of guiding an autonomous tool towards a docking station, the docking station including: a docking module for detachably receiving the autonomous tool, and a guiding module for guiding the movement of the autonomous tool towards the docking module, wherein the autonomous tool, upon the termination of the movement, is received by the docking module at a predetermined position and orientation, the method comprising the steps of:
(a) guiding, by the guiding module, the movement of the autonomous tool towards the docking module;
(b) receiving, by the docking module, upon termination of the movement, the autonomous tool at the predetermined position and orientation.

23. The method of claim 22, further including step (a1), before step (a), of retrieving the position of the docking module relative to the autonomous tool.

24. The method of claim 23, wherein step (a1) further includes step (a2), following step (a1), of deriving a path for the movement of the autonomous tool towards the docking module.

25. The method of claim 22, wherein the guiding module is extended from the docking module and comprises at least one guiding member.

26. The method of claim 22, wherein the guiding module comprises a pair of guiding members with a first end adjacent to the docking module and a second end opposed.

27. The method of claim 26, wherein the pair of guiding members are extended from the docking module in a parallel manner.

28. The method of claim 26, wherein the pair of guiding members are extended from the docking module in a non-parallel manner.

29. The method of claim 28, wherein the pair of guiding members converge as they approach the detachable docking module such that the second ends of the pair of guiding members are spaced further apart than the first ends of the pair of guiding members.

30. The method of claim 26, wherein the first end of the guiding members are connected to form a substantially U-shaped guiding member.

31. The method of claim 26, wherein the first end of the guiding members are connected to form a substantially V-shaped guiding member.

32. The method of claim 22, wherein the docking module comprises a signal generating module the signal emitted by which is received by a signal detecting module of the autonomous tool.
